(19) United States
(12) Patent Application Publication
(10) Pub. No.: US 2016/0199969 A1
(43) Pub. Date: Jul. 14, 2016

(54) HYDRAULIC HAMMER HAVING VARIABLE STROKE CONTROL

(71) Applicant: Caterpillar Inc., Peoria, IL (US)

(72) Inventor: Cody MOORE, Waco, TX (US)

(73) Assignee: Caterpillar Inc., Peoria, IL (US)

(21) Appl. No.: 14/594,542

(22) Filed: Jan. 12, 2015

(51) Int. Cl. B25D 9/26

(52) U.S. Cl. CPC B25D 9/26

(57) ABSTRACT

A variable stroke control system for a hydraulic hammer is disclosed. The variable stroke control system may include a valve configured to selectively adjust a stroke length of a piston associated with the hydraulic hammer based on the direction of flow of pressurized fluid within the hydraulic hammer.

### TECHNICAL FIELD

The present disclosure is directed to a hydraulic hammer and, more particularly, to a hydraulic hammer having variable stroke control.

### BACKGROUND

Hydraulic hammers can be attached to various machines such as excavators, backhoes, tool carriers, or other like machines for the purpose of milling stone, concrete, and other construction materials. The hydraulic hammer is mounted to a boom of the machine and connected to a hydraulic system. High pressure fluid in the hydraulic system is supplied to the hammer to drive a reciprocating piston in contact with a work tool, which in turn causes the work tool to reciprocate while in contact with the construction material.

Typical hydraulic hammers drive the reciprocating piston to contact the work tool with the same continuous stroke. In other words, a stroke length of the reciprocating piston does not change during operation of the hammer. However, some hydraulic hammers are capable of changing the stroke length (e.g., between shorter and longer strokes), which can provide more efficiency in some hammer operations.

An exemplary system for changing the stroke length of a hydraulic hammer is disclosed in U.S. Pat. No. 5,669,281 (the '281 patent) that issued to Comarmond on Sep. 23, 1997. Specifically, the '281 patent discloses a percussive machine having a piston that slides in a cylinder and strikes a tool during each cycle. The percussive machine also has a top chamber and a bottom chamber which are fed sequentially with fluid through a distributor controlled by a control device. The percussive machine further includes a selector piston mounted in the cylinder. The selector piston may be controlled by the control device with pressurized fluid to shift the selector piston in and out of a position that lengthens the stroke of the piston.

Although the percussive machine of the '281 patent may be adequate for some applications, it may still be less than optimal. In particular, the percussive machine of the '281 patent may be overly complex and require many additional parts. As a result, retrofitting existing hydraulic hammers with one continuous stroke to have an adjustable stroke would be difficult to achieve with the percussive machine of the '281 patent. In addition, the percussive machine of the '281 patent operates initially in a short stroke mode and is later switched to long stroke mode after a period of operation. In some instances, however, it may be desirable to start in the long stroke mode initially to increase the efficiency of the hammer operation.

The disclosed system is directed to overcoming one or more of the problems set forth above and/or other problems of the prior art.

### SUMMARY

In one aspect, the present disclosure is directed to a variable stroke control system for a hydraulic hammer. The variable stroke control system may include a valve configured to selectively adjust a stroke length of a piston associated with the hydraulic hammer based on the direction of flow of pressurized fluid within the hydraulic hammer.

In another aspect, the present disclosure is directed to a variable stroke control system for a hydraulic hammer. The variable stroke control system may include an inlet groove formed around a piston associated with the hydraulic hammer and configured to receive pressurized fluid, and an outlet groove formed around the piston associated with the hydraulic hammer and configured to discharge the pressurized fluid. The variable stroke control system may also include a first valve configured to control a transition timing between upward and downward movements of the piston. The variable stroke control system may further include a first switch groove formed around the piston in between the inlet groove and the outlet groove and configured to switch a valve position of the first valve, and a second switch groove formed around the piston in between the inlet groove and the first switching groove and configured to accelerate a transition from an upward movement of the piston to a downward movement of the piston. The variable stroke control system may further include a second valve configured to selectively adjust a stroke length of the piston based on whether the first valve is in fluid communication with the second switch groove.

In yet another aspect, the present disclosure is directed to a hydraulic hammer system. The hydraulic hammer system may include a piston. The hydraulic hammer system may also include a routing assembly having a pump and a return tank. The routing assembly may be configured to direct pressurized fluid within the hydraulic hammer in a first direction or a in a second direction. The hydraulic hammer system may further include an inlet groove formed around the piston and configured to receive the pressurized fluid from the pump, and an outlet groove formed around the piston and configured to discharge the pressurized fluid to the return tank. The hydraulic hammer system may further include a first valve configured to control a transition timing between upward and downward movements of the piston. The hydraulic hammer system may further include a first switch groove formed around the piston in between the inlet groove and the outlet groove and configured to switch a valve position of the first valve, and a second switch groove formed around the piston in between the inlet groove and the first switching groove and configured to accelerate a transition from an upward movement of the piston to a downward movement of the piston. The hydraulic hammer system may further include a second valve configured to selectively adjust a stroke length of the piston based on the direction of flow of the pressurized fluid.

### BRIEF DESCRIPTION OF THE DRAWINGS

FIG. 1 is a pictorial illustration of an exemplary disclosed machine;

FIG. 2 is an exploded view of an exemplary disclosed hydraulic hammer assembly that may be used with the machine of FIG. 1; and

FIG. 3 is a schematic illustration of an exemplary disclosed variable stroke control system that may be used with the hydraulic hammer of FIG. 2.

### DETAILED DESCRIPTION

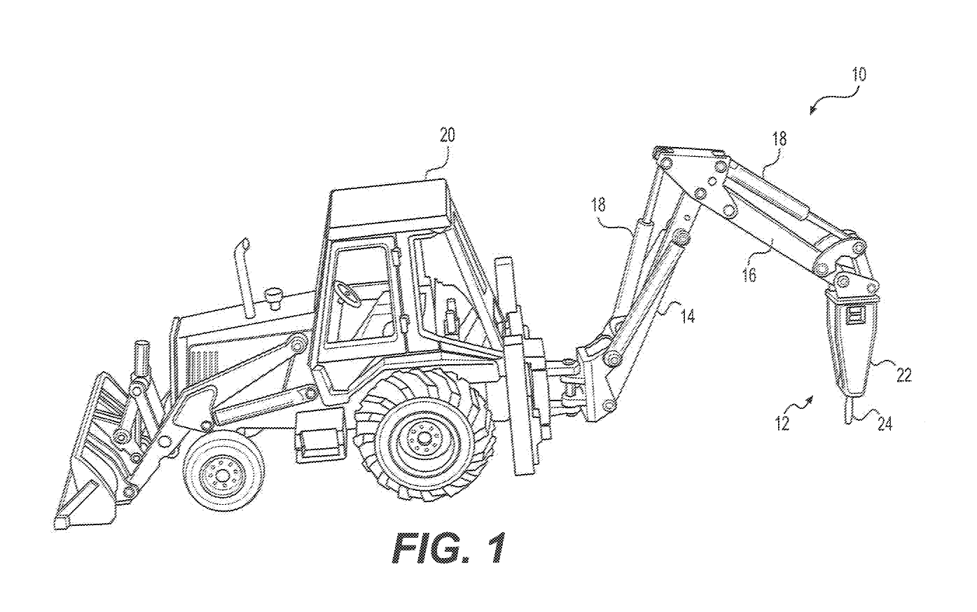

FIG. 1 illustrates an exemplary disclosed machine 10 having a hammer 12. Machine 10 may he configured to perform work associated with a particular industry such as, for example, mining or construction. Machine 10 may be a backhoe loader (shown in FIG. 1), an excavator, a skid steer loader, or any other machine. Hammer 12 may be pivotally connected to machine 10 through a boom 14 and a stick 16. However, it is contemplated that another linkage arrangement may alternatively be utilized, if desired.

In the disclosed embodiment, one or more hydraulic cylinders 18 may raise, lower, and/or swing boom 14 and stick 16 to correspondingly raise, lower, and/or swing hammer 12. The hydraulic cylinders 18 may be connected to a hydraulic supply system (not shown) within machine 10. Specifically, machine 10 may include a pump (not shown) connected to hydraulic cylinders 18 and to hammer 12 through one or more hydraulic supply lines (not shown). The hydraulic supply system may introduce pressurized fluid, for example oil, from the pump into the hydraulic, cylinders 18 and hammer 12. Operator controls for movement of hydraulic cylinders 18 and/or hammer 12 may be located within a cabin 20 of machine 10.

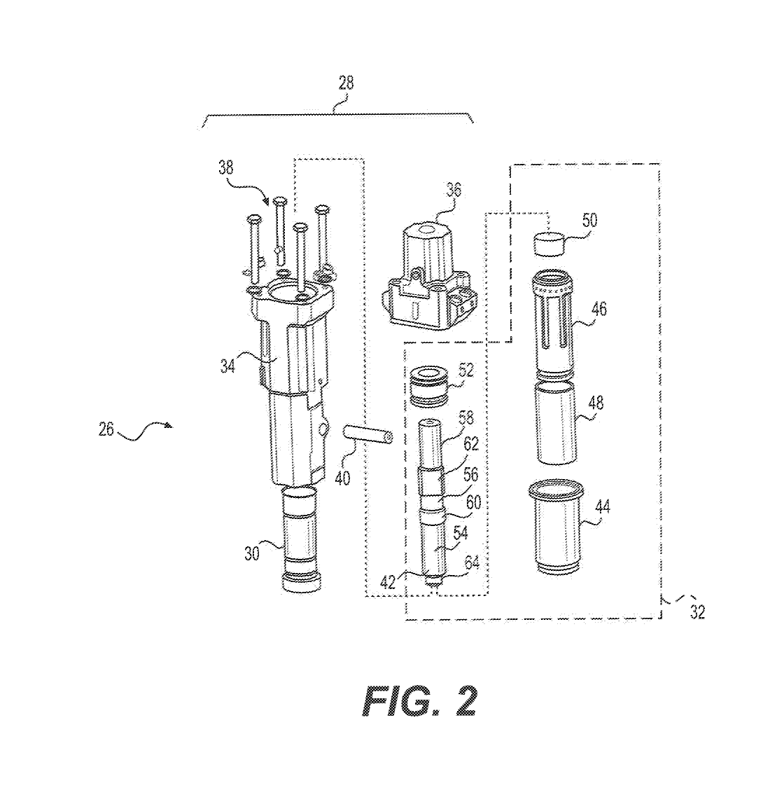

As shown in FIGS. 1 and 2, hammer 12 may include an outer shell 22 and an actuator assembly 26 located within outer shell 22. Outer shell 22 may connect actuator assembly 26 to stick 16 and provide protection for actuator assembly 26. A work tool 24 may be operatively connected to an end of actuator assembly 26 opposite stick 16. It is contemplated that work tool 24 may include any known tool capable of interacting with hammer 12. In one embodiment, work tool 24 includes a chisel bit.

As shown in FIG. 2, actuator assembly 26 may include a subhousing 28, a bushing 30, and an impact system 32. Subhousing 28 may include, among other things, a frame 34 and a head 36. Frame 34 may be a hollow cylindrical body having one or more flanges or steps along its axial length. Head 36 may cap off one end of frame 34. Specifically, one or more flanges on head 36 may couple with one or more flanges on frame 34 to provide a sealing engagement. One or more fastening mechanisms 38 may rigidly attach head 36 to frame 34. In some embodiments, fastening mechanisms 38 may include, for example, screws, nuts, bolts, or any other means capable of securing the two components. Additionally, frame 34 and head 36 may each include holes to receive fastening mechanisms 38.

Bushing 30 may be disposed within a tool end of subhousing 28 and may be configured to connect work tool 24 to impact system 32. A pin 40 may connect bushing 30 to work tool 24. When displaced by hammer 12, work tool 24 may be configured to move a predetermined axial distance within bushing 30.

Impact system 32 may be disposed within an actuator end of subhousing 28 and be configured to move work tool 24 when supplied, with pressurized fluid. As shown by the dotted lines in FIG. 2, impact system 32 may be an assembly including a piston 42, an accumulator membrane 44, a sleeve 46, a sleeve liner 48, a valve 50, and a seal carrier 52. Sleeve liner 48 may be assembled within accumulator membrane 44, sleeve 46 may be assembled within sleeve liner 48, and piston 42 may be assembled within sleeve 46. All of these components may be generally co-axial with each other. In addition, piston 42, sleeve 46, valve 50, and seal carrier 52 may all be held together as a sub-assembly by way of slip-fit radial tolerances. For example, slip-fit radial tolerances may be formed between sleeve 46 and piston 42, and between seal carrier 52 and piston 42. Sleeve 46 may apply an inward radial pressure on piston 42, and seal carrier 52 may apply an inward radial pressure on piston 42. Such a configuration may hold sleeve 46, seal carrier 52, and piston 42 together as a sub-assembly.

Accumulator membrane 44 may form a cylindrical tube configured to hold a sufficient amount of pressurized fluid for hammer 12 to drive piston 42 through at least one stroke. Accumulator membrane 44 may be radially spaced apart from sleeve 46 when accumulator membrane 44 is in a relaxed state (i.e. not under pressure from pressurized gas). However, when accumulator membrane 44 is under pressure from the pressurized gas, no spacing may exist between accumulator membrane 44 and sleeve 46, and fluid flow therebetween may be inhibited.

Valve 50 may be assembled over an end of piston 42 and located radially inward of both sleeve 46 and seal carrier 52. A portion of seal carrier 52 may axially overlap with sleeve 46. Additionally, valve 50 may be disposed axially external to accumulator membrane 44. Valve 50 and seal carrier 52 may be located entirely within head 36. Accumulator membrane 44, sleeve 46, and sleeve liner 48 may be located within frame 34. Head 36 may be configured to close off an end of sleeve 46 when connected to frame 34.

Piston 42 may be configured to slide within both frame 34 and head 36. For example, piston 42 may be configured to reciprocate within frame 34 and contact an end of work tool 24. Specifically, a compressible gas (e.g., nitrogen gas) may be disposed in a gas chamber (not shown) located within head 36 at an end of piston 42 opposite bushing 30. Piston 42 may be slideably moveable within the gas chamber to increase and decrease the size of the gas chamber. A decrease in size of the gas chamber may increase the gas pressure within the gas chamber, thereby driving piston 42 downward to contact work tool 24.

Piston 42 may comprise varying diameters along its length, for example one or more narrow diameter sections disposed axially between wider diameter sections. In the disclosed embodiment, piston 42 includes three narrow diameter sections 54, 56, 58, separated by two wide diameter sections 60, 62. Narrow diameter sections 54, 56, 58 may cooperate with sleeve 46 to selectively open and close fluid pathways within sleeve 46. Piston 42 may further include an impact end 64 having a smaller diameter than any of narrow diameter sections 54, 56, 58. Impact end 64 may be configured to contact work tool 24 within bushing 30.

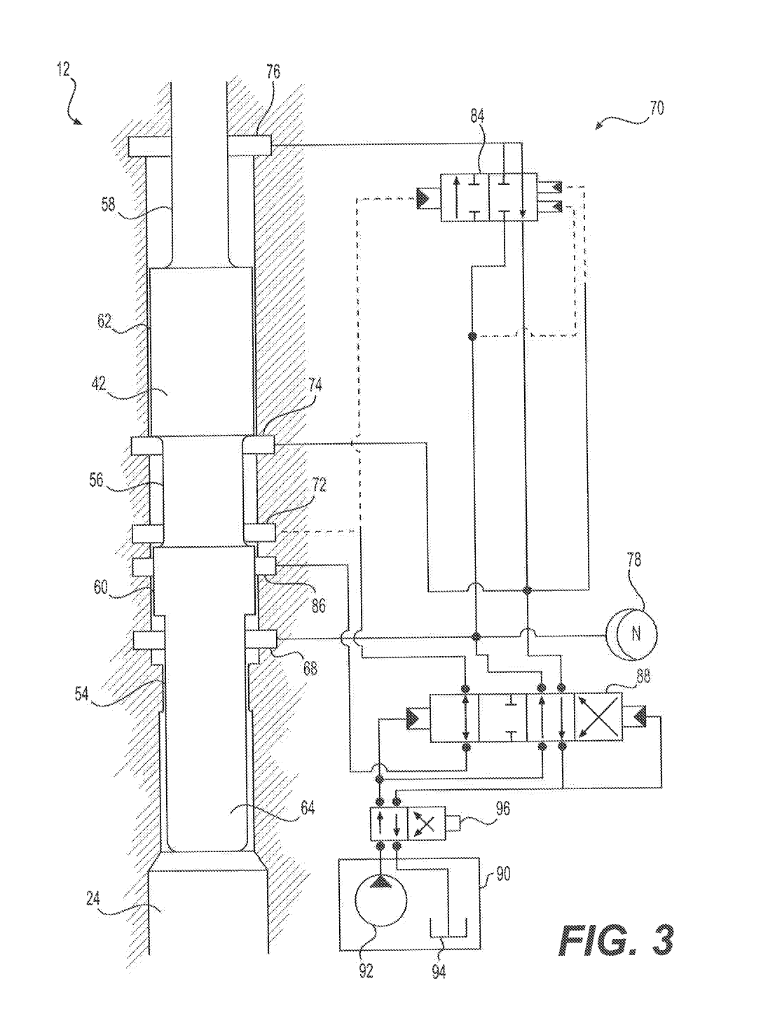

As shown in FIG. 3, hammer 12 may be equipped with a variable stroke control system 70. Variable stroke control system 70 may include one or more components configured to direct pressurized fluid within hammer 12 to selectively adjust a stroke length of piston 42. For example, variable stroke control system 70 may include an annular lift groove 68, an annular switch groove 72, an annular tank groove 74, an annular outlet groove 76, an accumulator 78, and a main control valve 84.

Lift groove 68 may be configured to direct pressurized fluid from a pump to contact a shoulder at wide diameter section 60 in order to force piston 42 in an upward direction. Switch groove 72 may be configured to fluidly communicate with main control valve 84 to switch a valve position of main control valve 84. Tank groove 74 and outlet groove 76 may be configured to direct the pressurized fluid to a return tank. Lift groove 68, switch groove 72, tank groove 74, and outlet groove 76 may all be formed as concentrically arranged passages around piston 42. Movement of piston 42 (i.e., of narrow diameter sections 54, 56, 58 and wide diameter sections 60, 62) may selectively open or close the grooves to cause movement of piston 42. Accumulator 78 may be configured to accumulate pressurized fluid and control pulsations of the fluid within hammer 12.

Main control valve 84 may be disposed between the pump and the return tank, and configured to control transition timing between movements of piston 42. In particular, main control valve 84 may control when piston 42 transitions between upward and downward movements. Main control valve 84 may include a valve element movable between two distinct positions. When the valve element is in the first position (right-most position shown in FIG. 3), outlet groove 76 may be fluidly connected to the return tank. When the valve element is in the second position (left-most position shown in FIG. 3), outlet groove 76 may be fluidly connected to the pump. In some embodiments, the valve clement may move between the first and second positions depending on a pressure level within the switch groove 72. Specifically, when the pressure level within the switch groove 72 is below a threshold amount, the valve element may be forced to the first position. Alternatively, when the pressure level within the switch groove 72 is greater than the threshold amount, the valve element may be forced to the second position.

As shown in FIG. 3, variable stroke control system 70 may also include an additional annular switch groove 86, a stroke control valve 88, and a fluid routing assembly 90. Switch groove 86 may be formed as a concentrically arranged passage around piston 42 in between lift groove 68 and switch groove 72. Like switch groove 72, switch groove 86 may be configured to fluidly communicate with main control valve 84 to switch a valve position of main control valve 84. However, as will be discussed in more detail below, the fluid communication between switch groove 86 may be selectively adjusted based on a position of stroke control valve 88.

Stroke control valve 88 may be configured to selectively adjust the stroke length of piston 42 based on a direction of flow of pressurized fluid within hammer 12. Stroke control valve 88 may include two valve elements movable together between two distinct positions. When the valve elements are in the first position (left-most position shown in FIG. 3), switch groove 86 may be in fluid communication with main control valve 84. When the valve elements are in the second position (right-most position shown in FIG. 3), the fluid communication between switch groove 86 and main control valve 84 may be blocked. The valve elements may move between the first and second positions depending on which direction the pressurized fluid flows within hammer 12. Specifically, when the pressurized fluid flows within hammer 12 in a first direction, the valve elements may be forced to the first position. Alternatively, when the pressurized fluid flows within hammer 12 in a second direction, the valve elements may be forced to the second position. In one embodiment, stroke control valve 88 may be located within hammer 12.

Routing assembly 90 may include a pump 92 and a return tank 94. Pressurized fluid may flow within hammer 12 from pump 92 to return tank 94 in one of two directions. Specifically, an operator may select a direction of flow of pressurized fluid within hammer 12 via an operator control valve 96 (e.g., a thumbwheel) located in cabin 20 of machine 10. Operator control valve 86 may include a valve element movable between two distinct positions. When the valve element is in the first position (left-most position shown in FIG. 3), pressurized fluid may flow within hammer 12 from pump 92 to return tank 94 in the first direction. When the valve element is in the second position (right-most position shown in FIG. 3), pressurized fluid may flow within hammer 12 from pump 92 to return tank 94 in the second direction. The valve element may move between the first and second positions based on an operator input (e.g., forcing the thumbwheel to one of two positions).

In the disclosed embodiment, by changing the direction of flow of pressurized fluid within hammer 12, the stroke length of piston 42 is changed between shorter strokes and longer strokes (i.e., the stroke length of piston 42 is decreased or increased). For example, when pressurized fluid flows through hammer 12 in the first direction, stroke control valve 88 may allow fluid communication between switch groove 86 and main control valve 84. This fluid communication may cause main control valve 84 to switch from the first position (right-most position shown in FIG. 3) to the second position (left-most position shown in FIG. 3) sooner, which results in a shorter stroke of piston 42. On the other hand, when pressurized fluid flows through hammer 12 in the second direction, stroke control valve 88 may block fluid communication between switch groove 86 and main control valve 84. This blockage will allow piston 42 to move further upwards, until switch groove 72 causes main control valve 84 to switch from the first position (right-most position shown in FIG. 3) to the second position (left-most position shown in FIG. 3), which results in a longer stroke of piston 42.

In some embodiments, a distance between switch groove 72 and switch groove 86 may affect a difference in length between the shorter stroke of piston 42 and the longer stroke of piston 42. For example, by increasing the distance between switch groove 72 and switch groove 86, the difference between the shorter stroke of piston 42 and the longer stroke of piston 42 may increase. Similarly, by decreasing the distance between switch groove 72 and switch groove 86, the difference in length between the shorter stroke of piston 42 and the longer stroke of piston 42 may decrease.

### INDUSTRIAL APPLICABILITY

The disclosed variable stroke control system may be used in any hydraulic hammer application. In particular, the disclosed variable stroke control system may allow an operator to manually adjust a stroke length of a piston of the hydraulic hammer by changing a direction of flow of pressurized fluid within the hydraulic hammer. Operation of hammer 12 will now be described in detail.

Referring to FIG. 3, an operator request may be made to begin operation of hammer 12. For example, the operator may select a desired direction of flow of pressurized fluid within hammer 12 via operator control valve 96. If the operator desires pressurized fluid to flow in the first direction, the operator may force operator control valve 96 to the first position (left-most position shown in FIG. 3), if the operator desires pressurized fluid to flow in the second direction, the operator may force operator control valve 96 to the second position (right-most position shown in FIG. 3).

When operator control valve 96 is in the first position, pump 92 may direct pressurized fluid, for example pressurized oil, into lift groove 68 and accumulator 78 in the first direction. A sufficient amount of oil within lift groove 68 may apply an upward pressure on piston 42. Specifically, the oil within lift groove 68 may apply pressure to the shoulder of wide diameter section 60 and bias piston 42 upward.

Movement of piston 42 upward may open switch groove 86. Specifically, movement of piston 42 upward may correspondingly move narrow diameter section 54 to a location adjacent to switch groove 86. While switch groove 86 is uncovered, pressurized fluid may flow from inlet groove 68 into switch groove 86, thereby increasing the pressure level at switch groove 86 and causing main control valve 84 to be switched from the first position (right-most position shown in FIG. 3) to the second position (leftmost position shown in FIG. 3). Subsequently, pressurized fluid from pump 92 may he allowed to flow through main control valve 84 and towards outlet groove 76.

As pressurized fluid flows from pump 92 through main control valve 84 and towards outlet groove 76, movement of piston 42 upwards may also cause narrow diameter section 58 to reduce the size of the gas chamber. This reduction in size may further pressurize nitrogen gas within the gas chamber, thereby biasing piston 42 downward. Such biasing may increase the pressure downward on piston 42, causing piston 42 to accelerate downward and contact work tool 24, which in turn causes work tool 24 to accelerate downward and impact a construction material. At an impacting position (as shown in FIG. 3), switch groove 72 may be in fluid communication with tank groove 74, which decreases the pressure level at switch groove 72 and causes main control valve 84 to be switched back to the first position (right-most position shown in FIG. 3). The impact with the construction material may then cause piston 42 to accelerate upwards.

When operator control valve 96 is in the second position, pump 92 may direct pressurized oil into lift groove 68 and accumulator 78 in the second direction. Similar to when pressurized fluid flows within hammer 12 in the first direction, the oil may cause movement of piston 42 upwards and downwards. However, while pressurized fluid flows within hammer 12 in the second direction, fluid communication between switch groove 86 and main control valve 84 may be blocked. Thus, upon movement of piston 42 upwards, main control valve 84 will not he switched from the first position (right-most position shown in FIG. 3) to the second position (left-most position shown in FIG. 3) until piston 42 reaches switch groove 72. As a result, this may delay a switching operation of main control valve 84. In particular, as piston 42 accelerates upwards, main control valve 84 may take longer to switch from the first position (right-most position shown in FIG. 3) to the second position (left-most position shown in FIG. 3). This may allow piston 42 to move further upwards, resulting in a longer stroke of piston 42 that provides higher impact energy and lower frequency than the stroke of piston 42 when oil flows through hammer 12 in the first direction.

Piston 42 may continue to reciprocate up and down in shorter or longer strokes in response to the direction of flow of pressurized fluid controlled by the operator. Because of the simplified operation of switching groove 86 and stroke control valve 88, piston 42 can easily switch between longer and shorter strokes by switching the direction of flow of pressurized fluid within hammer 12. The use of switching groove 86 and stroke control valve 88 may simplify a variable stroke control operation and be suitable for retrofitting hydraulic hammers having non-variable stroke control. In addition, the operator may be capable of starting the hammer operation with either a short stroke or a long stroke depending on the operator's selection.

It will be apparent to those skilled in the art that various modifications and variations can he made to the system of the present disclosure. Other embodiments of the system will be apparent to those skilled in the art from consideration of the specification and practice of the method and system disclosed herein. It is intended that the specification and examples be considered as exemplary only, with a true scope of the disclosure being indicated by the following claims and their equivalents.

What is claimed is:

1. A variable stroke control system for a hydraulic hammer, comprising:
a valve configured to selectively adjust a stroke length of a piston associated with the hydraulic hammer based on the direction of flow of pressurized fluid within the hydraulic hammer.

2. The variable stroke control system of claim 1, wherein the valve is configured to cause the stroke length of the piston to decrease when the pressurized fluid flows within the hydraulic hammer in a first direction.

3. The variable stroke control system of claim 1, wherein the valve is configured to cause the stroke length of the piston to increase when the pressurized fluid flows within the hydraulic hammer in a second direction.

4. The variable stroke control system of claim 1, further including a routing assembly having a pump and a return tank, and configured to direct pressurized fluid within the hydraulic hammer in a first direction or in a second direction.

5. The variable stroke control system of claim 4, further including an operator control valve configured to receive an operator input indicative of a desire to direct the pressurized fluid in the first direction or in the second direction.

6. The variable stroke control system of claim 1, wherein the valve is a first valve, and the variable stroke control system further includes a second valve configured to control a transition timing between upward and downward movements of the piston.

7. The variable stroke control system of claim 6, further including:
an inlet groove formed around the piston and configured to receive pressurized fluid;
an outlet groove formed around the piston and configured to discharge the pressurized fluid;
a first switch groove formed around the piston in between the inlet groove and the outlet groove and configured to switch a valve position of the second valve; and
a second switch groove formed around the piston in between the inlet groove and the first switch groove and configured to accelerate a transition from an upward movement of the piston to a downward movement of the piston.

8. The variable stroke control system of claim 7, wherein the second switch groove is in fluid communication with the second valve when the pressurized fluid flows within the hydraulic hammer in a first direction.

9. The variable stroke control system of claim 7, wherein the second switch groove is not in fluid communication with the second valve when the pressurized fluid flows within the hydraulic hammer in a second direction.

10. The variable stroke control system of claim 7, wherein a distance between the first switch groove and the second switch groove affects a difference in length between a shorter stroke of the piston and a longer stroke of the piston.

11. A variable stroke control system for a hydraulic hammer, comprising:
an inlet groove formed around a piston associated with the hydraulic hammer and configured to receive pressurized fluid;
an outlet groove formed around the piston and configured to discharge the pressurized fluid;
a first valve configured to control a transition timing between upward and downward movements of the piston;
a first switch groove formed around the piston in between the inlet groove and the outlet groove and configured to switch a valve position of the first valve;
a second switch groove formed around the piston in between the inlet groove and the first switching groove and configured to accelerate a transition from an upward movement of the piston to a downward movement of the piston; and
a second valve configured to selectively adjust a stroke length of the piston based on whether the first valve is in fluid communication with the second switch groove.

12. The variable stroke control system of claim 11, wherein the second valve is configured to allow fluid communication between the first valve and the second switch groove when the pressurized fluid flows within the hydraulic hammer in a first direction.

13. The variable stroke control system of claim 12, wherein the fluid communication between the first valve and the second switch groove causes the stroke length of the piston to decrease.

14. The variable stroke control system of claim 11, wherein the second valve is configured to block fluid communication between the first valve and the second switch groove when the pressurized fluid flows within the hydraulic hammer in a second direction.

15. The variable stroke control system of claim 14, wherein no fluid communication between the first valve and the second switch groove causes the stroke length of the piston to increase.

16. The variable stroke control system of claim 11, wherein a distance between the first switch groove and the second switch groove affects a difference in length between a shorter stroke of the piston and a longer stroke of the piston.

17. The variable stroke control system of claim 16, wherein increasing the distance between the first switch groove and the second switch groove increases the difference in length between the shorter stroke of the piston and the longer stroke of the piston.

18. The variable stroke control system of claim 16, wherein decreasing the distance between the first switch groove and the second switch groove decreases the difference in length between the shorter stroke of the piston and the longer stroke of the piston.

19. The variable stroke control system of claim 11, further including an operator control valve configured to receive an operator input indicative of a desire to direct the pressurized fluid in a first direction or in a second direction.

20. A hydraulic hammer system, comprising:
a piston;
a routing assembly having a pump and a return tank, and configured to direct pressurized fluid within the hydraulic hammer in a first direction or in a second direction;
an inlet groove formed around the piston and configured to receive the pressurized fluid from the pump;
an outlet groove formed around the piston and configured to discharge the pressurized fluid to the return tank;
a first valve configured to control a transition timing between upward and downward movements of the piston;
a first switch groove formed around the piston in between the inlet groove and the outlet groove and configured to switch a valve position of the first valve;
a second switch groove formed around the piston in between the inlet groove and the first switching groove and configured to accelerate a transition from an upward movement of the piston to a downward movement of the piston; and
a second valve configured to selectively adjust a stroke length of the piston based on the direction of flow of the pressurized fluid.
